(19) United States
(12) Patent Application Publication
(10) Pub. No.: US 2020/0159962 A1
(43) Pub. Date: May 21, 2020

(54) Untrackable Personalization Based on Previously Downloaded Content

(71) Applicant: Alter.com Inc., Metuchen, NJ (US)

(72) Inventor: Deven Patel, Metuchen, NJ (US)

(21) Appl. No.: 16/192,922

(22) Filed: Nov. 16, 2018

(51) Int. Cl. G06F 21/62; G06Q 30/04; H04L 29/08; G06F 16/954

(52) U.S. Cl. CPC G06F 21/6263; G06F 16/954; H04L 67/10; G06Q 30/04

(57) ABSTRACT

Viewing history is stored in local storage based on determined categories of content visited by the user of the local viewing device. The categories are determined and stored based on executable code sent with the content to be viewed. Subsequent content which is viewed has the same or other executable code which also modifies the content based on the categories previously determined as related to prior content viewed on the viewing device or viewing user and associated categories stored there-about. Servers used to effectuate the method, in embodiments of the disclosed technology, lack long term storage of the categories in a way which can associate the categories to a specific viewer.

### FIELD OF THE DISCLOSED TECHNOLOGY

The disclosed technology relates generally to dynamically changing content and, more specifically, to changing content based on data stored in a user device and prior content retrieved by a viewer.

### BACKGROUND OF THE DISCLOSED TECHNOLOGY

Dynamic and personalized content can be a great feature to include in downloadable content, but privacy issues abound. While cookies can store information about a user and their usage habits, they have a negative reputation because they can also be used to track a person's actions and viewing habits. What is needed is a way to be able to have the benefits for the user of sending them content, such as advertising, that is desired but without the invasion of privacy.

### SUMMARY OF THE DISCLOSED TECHNOLOGY

Embodiments of the disclosed technology include a server and methods of operating same. Such a server is connected to a network, such as via first network node (where a “node” is defined as a physical location with a device which receives packets of information and routes the information to a next destination or node on a network with a plurality of nodes). A device associated with a content viewer at another network node sends data which is received via the first network node and/or the server. The data includes an indication (explicit or implicitly indicating same) that the device associated with the content viewer has received content from a device associated with a content publisher. A list of keywords found in the content is determined, either by the device associated with the content viewer or the server and based on these keywords data is sent to the device associated with the content viewer to store the category information in a storage device residing at such the device.

In this manner, on the end user device, that is, the device associated with the content viewer, stores the identifying information about the category in embodiments of the disclosed technology while the server lacks long term storage thereof. (“Long term”, for purposes of this disclosure, is defined as one hour or twenty four hours and/or longer than necessary to ensure functioning of the method which can be as short as one second.) As such, the personal data about the person or device viewing the content and categories associated therewith, after the short term necessary to process the data, becomes unknown to the server and cannot later be hacked or used for nefarious purposes.

Then, in a second receiving of data via the first network node from the end user device, another indication that the end user device has received at least some content (additional content or the same content) from the device associated with the content publisher is received. The content viewer transmits to, and the server receives, the category information which is stored in a storage device on the content viewing device (also referred to as the device associated with the content viewer—the terms are used interchangeably for ease of reading). The storage device of the content viewer/content viewing device stores or is designed to store the category data long term.

In response to the second viewing of content from the content publisher and notification received by the server, the server then sends data in the form of code to be executed (read and interpreted to change the display of content shown on a display of the content viewing device) to modify a part of the content which was received from the content publisher. This can include adding additional content or replacing content received from the content publisher with other content received from the server by way of, or downloaded due to, the code. A fee is charged to the content publisher for the sending of the data to modify the content. This can be a one time, monthly, per user per month, or per use fee.

In some embodiments, an indication is received from the content viewer confirming that the content displayed at the viewer has been modified based on the category stored in the content viewer storage device. Such data is stored long term in the content viewer storage device in embodiments of the disclosed technology whereas the server lacks long term storage of any data pertaining to viewing history and the category of the content viewed by said content viewer. This may be done for privacy purposes.

The step of charging a fee to the content publisher can be charged based on a determination that content displayed by the content publisher was modified based on the data sent to the device associated with the content viewer to store the category. This determination can be made, in part or in full, based on receiving a version of the data received from the device associated with the content publisher and/or the content viewer.

The content publisher can be a single entity or device or can be a plurality of content publishers each providing different content associated with the category and/or additional categories. Thus, categories determined for a viewer can be by way of downloads of multiple different content publisher's content and/or via multiple web pages or the like. Each category of data determined can be stored in the viewing device and used to modify content of one or more content publishers whether the category was determined from the content publisher associated therewith or from a different content publisher. The category to be stored and data associated therewith can be sent based on any of the content publishers. The category data can be stored in a cookie on the content viewing device. A “cookie” for purposes of this disclosure is any local storage on the device associated with the content viewer which can be retrieved, upon request, by the server and/or a content publisher. A “cookie” can be the traditional cookie stored in a web browser or other items such as HTML (hypertext markup language) web storage, Web SQL, or the like. View count for each category can be updated with each viewer and priority given to more views of a particular category. Still further, once a category is displayed for a particular content publisher, this category can be held constant to provide a consistent viewing experience for the particular viewing device and/or user thereof.

The content which is modified, in embodiments of the disclosed technology, is modified while the content is being downloaded from the content publisher. That is, the modifications to the content are made based on the category and this occurs simultaneous to the unchanged content being downloaded. (“Simultaneous” is defined as “as close in time as the processors and network over which the method is carried out reasonably allow to occur.”)

A method of displaying content to a viewer thereof can also be carried out as follows. A request to download at least said static content is received and the static content is sent. At least some of the static content is designated as changeable content based on a category of interest of the viewer of the content. The static content has there-within code designed to instruct a device associated with the viewer to upload data with a category of interest to a third party server. This category data is then used for the third party server to provide other information to be displayed by the content viewer. The content viewer then changes the changeable content accordingly, based on the new data from the third party server which was, in turn, based on the category of interest stored at the viewing device prior to the static content download.

In some embodiments of the above method, a fee paying is paid to an operator of the third party server, the fee associated with determining the category of interest and modifying the static content with varied content. The category determination can be related to, or is, a specific gender of the viewer or content associated therewith. Categories can also be based on an area of interest of the viewer (person using the content viewing device). Such categories can be determined based on the static content viewed, viewed longest, the uniform resource locator (URL) associated with the content, and/or a name associated with a specific gender which is in the URL. A viewer may be sent an email with a link to view the content and the information about the user is already known, so that the URL is now associated with the content and therefore the category.

Instructions are sent to a device associated with the viewer to store the category of interest in embodiments of the disclosed technology. After sending the instructions, all data which is used to associate the viewer to the category of interest is deleted from the third party server and/or the content publisher and/or device used to carry out the method of embodiments of the disclosed technology. The third party server stores data about the various categories only short term and the data must be retrieved from the viewer to carry out the step of finding and exhibiting content and paying the fee in embodiments of the disclosed technology.

In some embodiments it is further determined that the viewer has requested the static content a second time. A new said category of interest of the viewer is determined and reported to the third party server in such cases, but as a previously determined category was determined the prior determined category is used in the second viewing in order to provide a consistent viewing experience to the viewer.

Any device or step to a method described in this disclosure can comprise or consist of that which it is a part of, or the parts which make up the device or step. The term “and/or” is inclusive of the items which it joins linguistically and each item by itself. “Substantially” is defined as “at least 95% of the term being described” and any device or aspect of a device or method described herein can be read as “comprising” or “consisting” thereof.

### BRIEF DESCRIPTION OF THE DRAWINGS

FIG. 1 shows a high level diagram of devices and steps carried out to modify content being displayed in an embodiment of the disclosed technology.

FIG. 2 shows a high level diagram of device and steps carried out to modify content being displayed when the content is being displayed a second time in an embodiment of the disclosed technology.

FIG. 3 shows a high level diagram of devices used to carry out embodiments of the disclosed technology.

FIG. 4 shows steps to a method of carrying out embodiments of the disclosed technology to modify content being displayed.

FIG. 4B shows steps to a method of carrying out an additional embodiments of the disclosed technology to modify content being displayed.

FIG. 5 shows a high level block diagram of devices used to carry out embodiments of the disclosed technology.

FIG. 6 shows an interface used by content publisher to set content categories stored on a third party server in an embodiment of the disclosed technology.

FIG. 7 shows a sample of content sent by a content publisher to a content viewer in an embodiment of the disclosed technology.

FIG. 8 shows a sample of static content sent by a content publisher to a content viewer being the content is modified in an embodiment of the disclosed technology.

FIG. 9 shows a sample of the static content of FIG. 8 after being modified based on data transfer between the content viewer, a third party server, and the category determined based on the content viewed in FIG. 7 in an embodiment of the disclosed technology.

### DETAILED DESCRIPTION OF EMBODIMENTS OF THE DISCLOSED TECHNOLOGY

Content displayed on a display screen, such as in a webpage being displayed with a portion thereof changed before or after all the static content is displayed to a viewer. This is accomplished through executable code sent with the content which is used to determine and store categories of interest on the viewing device based on content viewed at present or previously by the viewing device (including a particular user thereof). Long term, the categories of interest are stored only by the viewing device or devices where the end user data is stored while the content publisher or third party server stores only as necessary to carry out the afore-described method (e.g. lacks long term storage of categories associated with an identifiable viewing device or user). The content is changed based on providing category information of current or past viewed content to the third party server which returns data usable to modify the static content with the changed content based on the category. If the particular content was previously modified for a particular viewer or viewing device, the way the content was previously modified can be carried out again despite a determined category of interest change. The content publisher is charged a fee for each change of content in some embodiments of the disclosed technology.

Embodiments of the disclosed technology will become more clear in view of the following description of the figures.

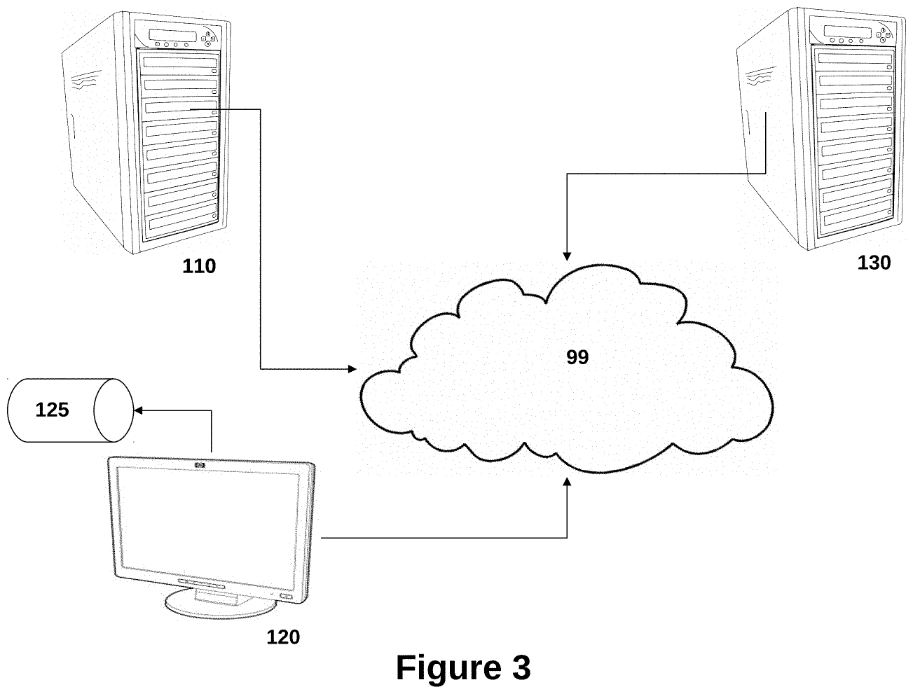

Beginning with FIG. 3, FIG. 3 shows a high level diagram of devices used to carry out embodiments of the disclosed technology. This includes a content publisher 110 which is connected to a network node and the “Internet” 99 via such a network node. The content publisher, in a general sense, stores content and/or code which is sent to a viewing device upon request which will render or otherwise display the code in a human usable format such as with text and/or graphics. The network nodes are physical hardware switches or routers which receive packets of data and direct and re-transmit same to another node on the network and may temporarily store the data. The “Internet” 99 is a collection of such networks nodes, hardware switches, and routers which connect to transport data from one physical hardware device to another at ends of series of network nodes using the tcp/ip (transport control protocol/internet protocol) system for communicating such data.

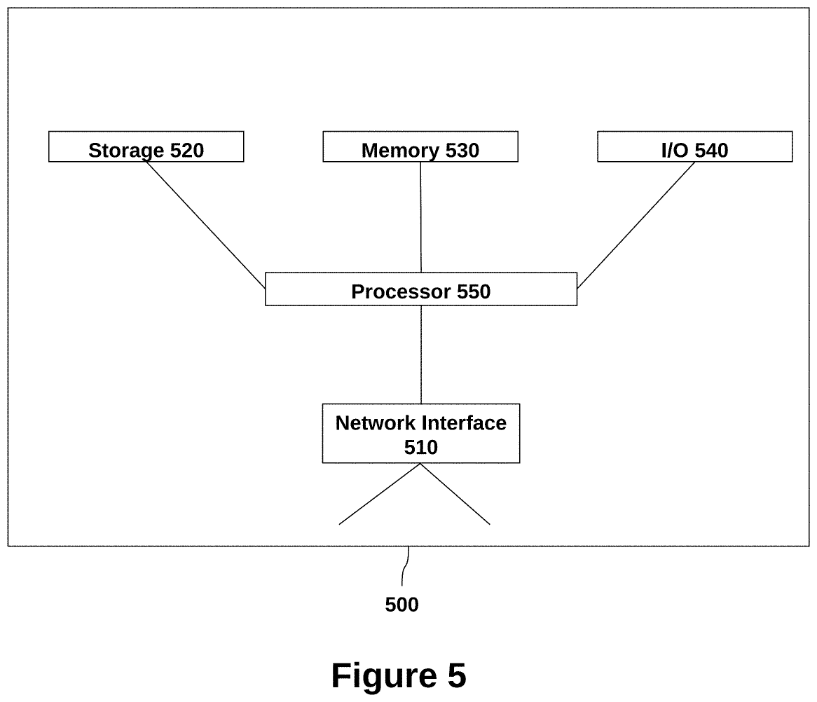

The third party server 130, in embodiments of the disclosed technology, is used to carry out methods of the disclosed technology such as to handle receiving and sending of payments and/or accounting there-for and sending code to modify content displayed on a viewing device 120. The viewing device 120 is a device which is used to view content displayed which has been received via the network and nodes on which each device is attached. The viewing device can be one or more physical devices as long as the devices are associated with a particular user/viewer and have stored content of the user accessible when content is being received. Such stored content of the user can be a cookie or the like (see definition in the ‘summary’). A stored device 125 is a physical hardware storage device having long term storage capabilities which stores the cookie. In general, the viewing device 120 receives content for display from the content publisher 110, executes code such as Javascript code and determines category based on the content received in this or a previous interaction, sends this category information to a third party server 130 which then uses the data to received to send replacement data to the content viewer 120 which changes the displayed data in real-time, such as while the content is being received and rendered on a display device. The devices described herein are described with their component parts in FIG. 5.

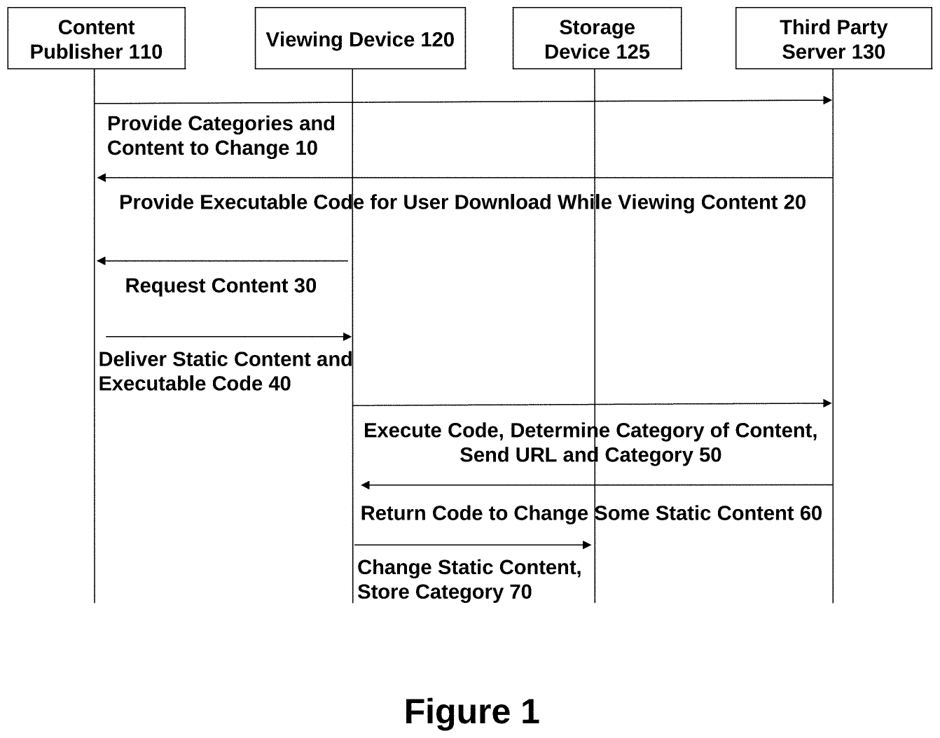

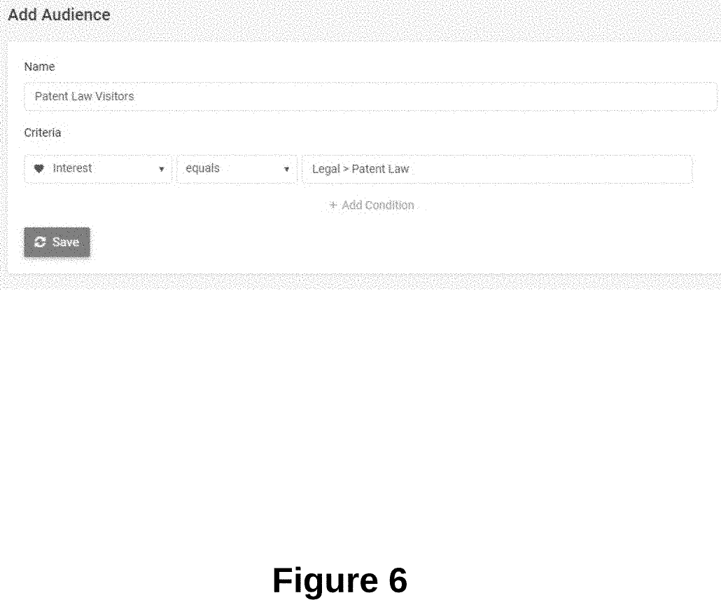

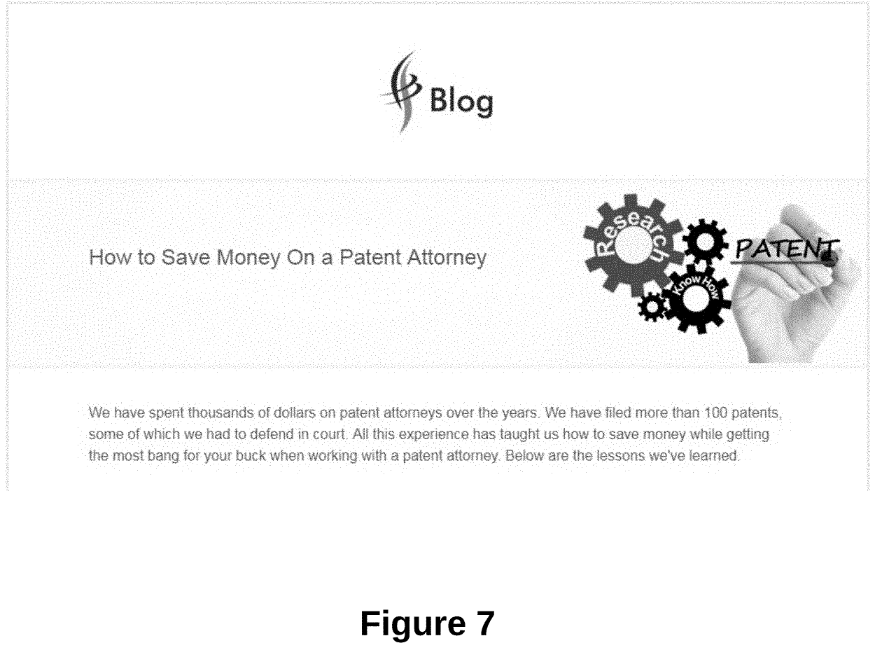

In more specific steps, FIG. 1 shows a high level diagram of devices and steps carried out to modify content being displayed in an embodiment of the disclosed technology. The devices shown are those described with reference to FIG. 3. The content publisher provides categories and content which is to be changed in step 10. FIG. 6 shows a sample an interface used by content publisher to set content categories stored on a third party server in an embodiment of the disclosed technology. In the example shown, the category is set as “Patent Law Visitors” which are people who show an interest in patent law. The third party server receives this data and there is an association made between content that a viewer requests and their category of interest. This may be because the content downloaded is related to a specific topic, such as if they visit a blog article on a website of the content publisher 110 or another party related to a particular category. FIG. 7 shows an example of this as it is a sample of content sent by a content publisher to a content view in an embodiment of the disclosed technology. In this example, the content is related to patents and patent law. This will be discussed in greater detail later with respect to the viewing device 120.

Returning to FIG. 1, in step 20 (which can take place before or after step 10), executable code is provided by the third party server 130 and/or used by the content publisher 110 when delivering content/data to the viewing device in step 40. In step 40, after the viewing device 120 has requested specific content from the content publisher 110 (in step 30), the content publisher 110 delivers the content there-to. The content delivered includes the executable code, such as Javascript code, which, in step 50, is executed (instructions within the code are carried out) to scan the content received from the content publisher 110 and determine a category of the content. Information sufficient to determine which content was downloaded (such as a uniform resource locator) and the category is sent to the third party server 130. The category is analyzed and matched to one of the categories determined in step 10 for this particular content publisher. Code is then returned to the viewing device 120 to change some of the static content according in step 60. The code is then changed by the viewing device 120 in some iterations of step 70 and the category is stored in the storage device 125 held within or having long term data storage designed to be accessed and used only by the viewing device 120. In some iterations of the step 70, where a category already stored in the storage device 75 is retrieved and matches that of the content received from the content publisher 110, the static content is modified to display changed content received from the third party server 130 based on the previously stored category in the storage device 125, as provided by the content publisher 110 in step 10.

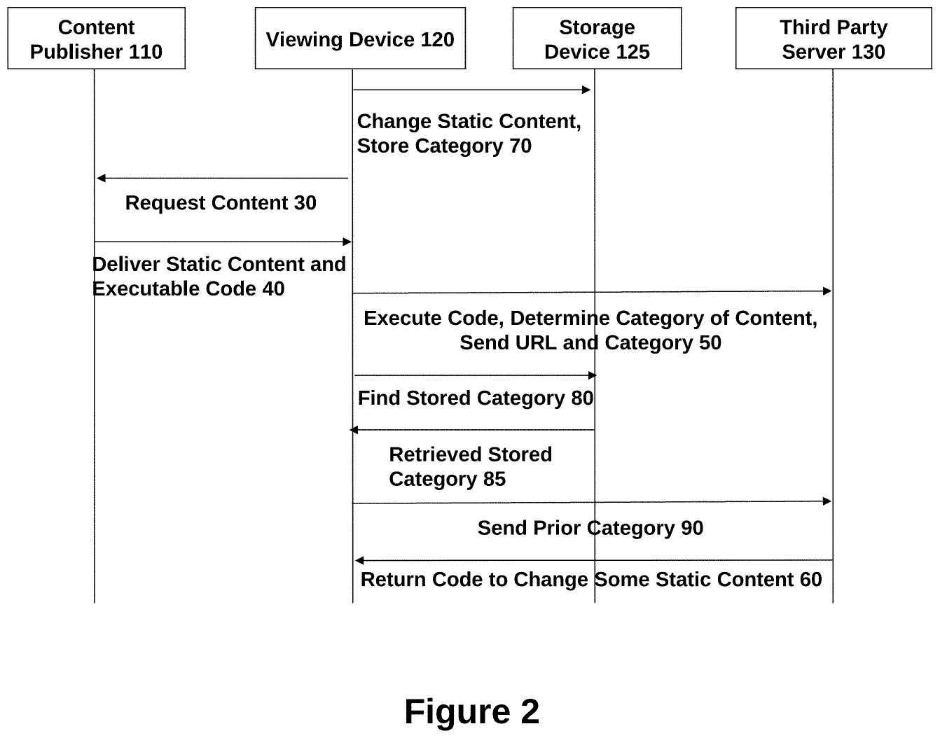

FIG. 2 shows a high level diagram of device and steps carried out to modify content being displayed when the content is being displayed a second time in an embodiment of the disclosed technology. The devices shown in the top row and the same as those shown with respect to FIGS. 1 and 3. Where the steps have the same number as those described in FIG. 1, the steps are the same are similar albeit carried out in a different order. Thus, in step 70, the final step shown in FIG. 1, the static content is changed and the category information is stored in the viewing device 120 and a storage device associated therewith 125 (local storage). In addition to keywords or categories stored, other information is also stored in the cookie or local storage in embodiments of the disclosed technology. This can include past web pages viewed and the time viewed. Additionally, any other user specific information can be stored in the cookie directly like gender or traffic source. Now the method is ready to be carried out a second time, but this time a category of interest is already known and stored in the viewing device 120. When content is requested in a second time in the new iteration of step 30, the content publisher again provides static content with executable code in step 40.

This static content can be the same content (e.g. the same uniform resource locator) or different content (e.g. using a different uniform resource locator). The code downloaded with the content is again executed in step 50 but this time the category is determined based on finding a stored category in step 80, the stored category having been previously stored in the storage device 125. This stored category is retrieved in step 85. As such, when there is a previously known category based on what has been stored in the storage device 125 during a previous downloading of content, now when viewing the same or different content the stored category can be retrieved. Step 50 then comprises there-within step 90 where the category of content sent in step 50 is actually the retrieved category in step 85, send to the third party server 130 in step 90.

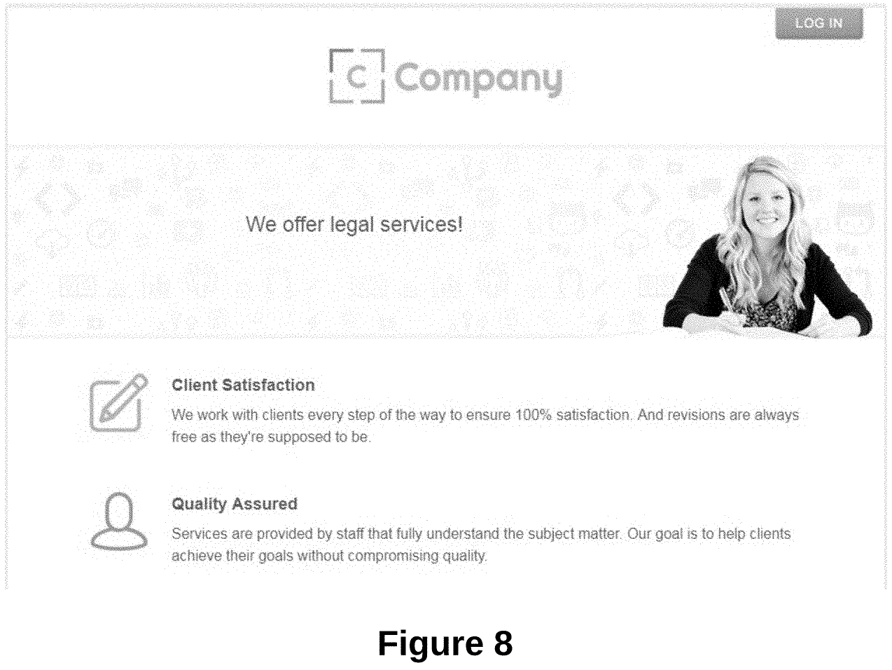

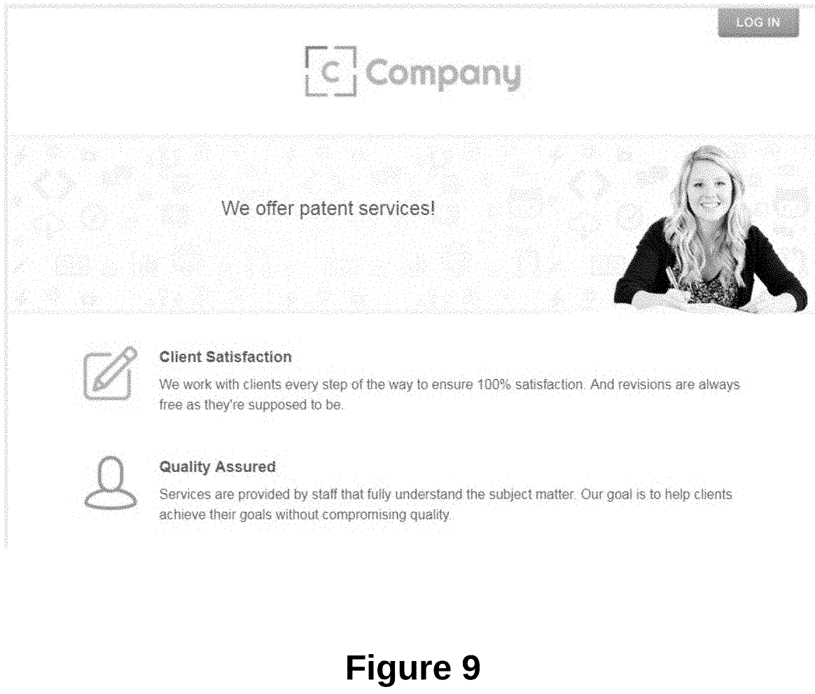

The code returned in step 60 changes the content according to the category which was stored in the storage device 125 in some embodiments of the disclosed technology. This is useful where, for example, one wants to give a consistent viewing experience such that the content is changed the same way each time for a particular viewer or where the viewer is viewing multiple different articles or units of content (such as URLs) and the category is gleaned from a particular unit of content and is used when displaying another unit of content. This is shown in FIGS. 8 and 9, for example. A truncated epoch or timestamp for each category viewed, content unit, or web page viewed is stored in the local storage device in some embodiments of the disclosed technology. Thus, based on view count or multiple confirmations, for example, that certain content has been viewed or a certain category has been confirmed, one can give more weight to future category determinations.

FIG. 8 shows a sample of static content sent by a content publisher to a content viewer being the content is modified in an embodiment of the disclosed technology. FIG. 9 shows a sample of the static content of FIG. 8 after being modified based on data transfer between the content viewer, a third party server, and the category determined based on the content viewed in FIG. 7 in an embodiment of the disclosed technology. Recall that in FIG. 7, a viewer requested content related to a patent attorney. This might be in a first iteration of carrying out step 30. In FIG. 8, the content downloaded in step 30 includes content offering legal services. However, since the category of “patent attorney” was stored, in this example, in the storage device 125 in step 70, it is retrieved in step 85 and sent in step 90 causing the words, in this example, of “legal services” in FIG. 8 to be changed during or after receipt/display of the content. The words, as shown in FIG. 9, are changed to “patent services.” In this manner, the content is tailored to the needs of the viewer of the content.

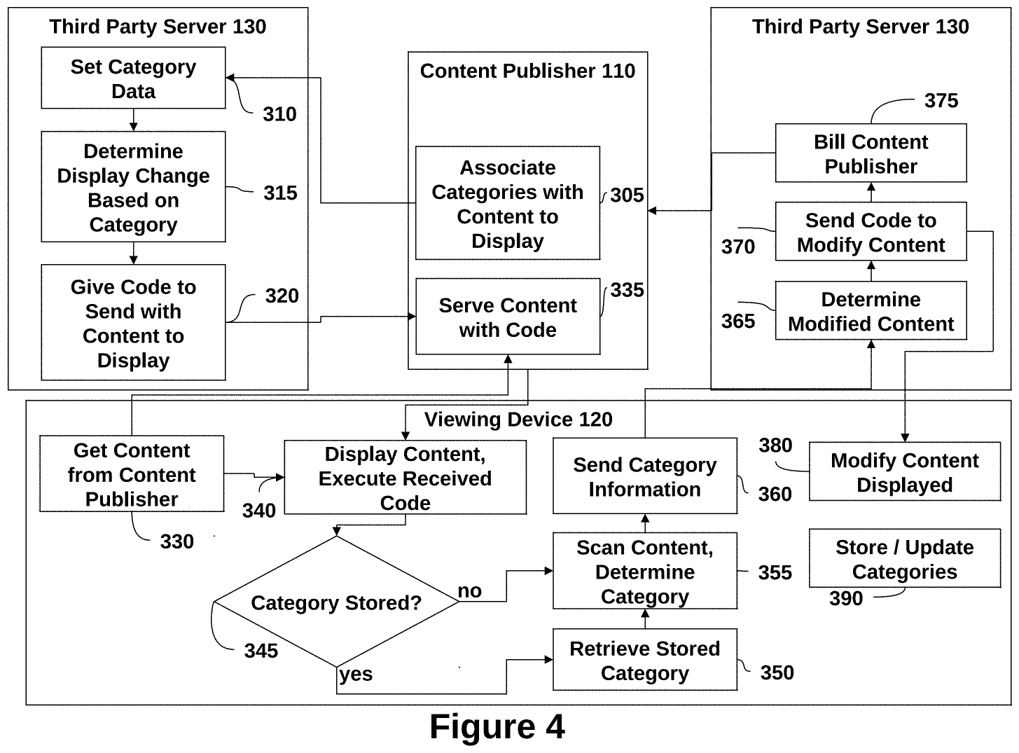

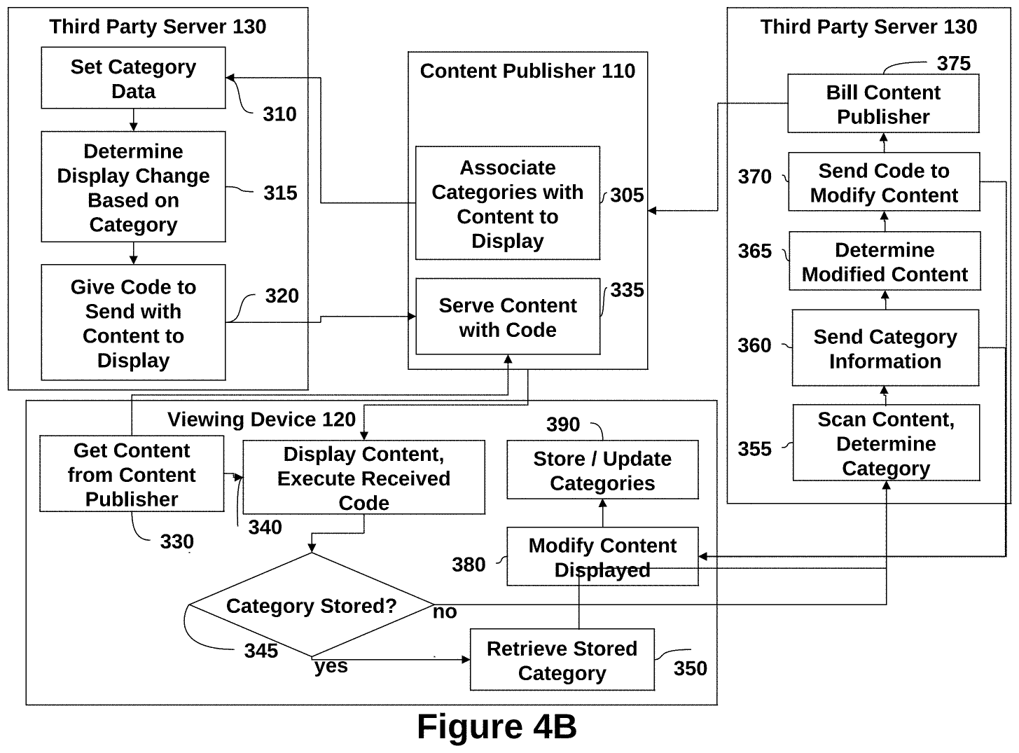

FIG. 4 shows steps to a method of carrying out embodiments of the disclosed technology to modify content being displayed. Steps which are substantially or fully carried out by the third party server 130, content publisher 110, and viewing device 120 are shown in their respective boxes. The earlier steps of the third party server 130 are in the box on the left while the later steps of the third party server 130 (before the content is viewed) are in the box on the right (after the content is viewed or sent, at least in part). In step 305, the content publisher 110 interacts with the third party server 130 to determine what categories will be set along with what content to display for each category. The categories can be “sex” with “male” and “female” as answers. This can be determined later by providing a URL, such as in email marketing campaigns, which are different for male verses female customers and/or based on the first name of the recipient. A customer might receive a URL (uniform resource locator) with their name in it, such as “DeShawn” which would be determined to be male and “Rivka” which would be determined to be female. As such, the content associated with each category can be changed accordingly. Thus, “category”, for purposes of this disclosure, is an identifiable characteristic or interest which distinguishes what the final displayed content will be compared to other final displayed content for another. By interacting with the third party server 305 (or/including an interface which direct the results to be stored on the third party server 305), in step 310 the category data and associated content with each category is set. Thus, step 315 is carried out whereby it is determined what code or text of content will be replaced with what other content. The code to effectuate such a change of displayed content is given by third party server 130 or another acting on behalf of an operator of the server 130 and/or based on instructions provided by an operator thereof (all of which are included and synonymous for the purpose of the claims). Such code in step 320 is given to the content publisher to embed with the content to be downloaded. In step 335, the content publisher 110 will serve this code to a device, via network nodes, which requests content for download.

Now referring to the steps carried out by the viewing device 120 in FIG. 4, in step 330 content is downloaded from the content publisher 110. This content has within it code which is executable to communicate with the third party server 130. The content, such as static content (content which will remain the same throughout the steps of the method described herein) is displayed along with changeable content. If no category is located, then the changeable content may be the original content displayed and may refrain from being changed. This can happen when in step 345, there is no prior category stored or there is no match between categories set by the content publisher 110 and that of the viewing device 120. When there is a stored category, found in step 345, the stored category is retrieved in step 350 from storage located at or available to the viewing device 120 (to the exclusion of the third party server 130 and content publisher 110, except by way of the viewing device 120). Whether or not a stored category is found in the viewing device 110, step 355 is carried out in embodiments of the disclosed technology to scan the content downloaded and determine a category or categories associated therewith. In step 355, the category is also determined. This may be carried out by the third party server in some embodiments of the disclosed technology.

The category is based, in embodiments of the disclosed technology, on one or more of: a) a prior category used for a particular category, b) the content currently being viewed, c) the URL used to reach the content, d) prior content viewed by the viewer with a stored category associated therewith. The category information, such as the current and/or prior determined categories, are sent in step 360 to the third party server 130. Based on the category determined in step 360, the replacement content is determined in step 365 which is sent back to the viewing device 120 in step 370. The executable code, executed in step 340, is used to receive this replacement content (or code sufficient to generate the replacement content) and replace the changeable content or some thereof with the replacement content. Thus, in step 380 the viewing device 120, at the instruction of the third party server which is a separate device/entity than the content publisher 110, replaces some downloaded content, downloaded in step 330 form the content publisher 110 with content downloaded from the third party server 130. The viewing device then stores or updates the stored categories in step 390 which will be retrieved in another iteration of downloaded content and carrying out of step 345 and 350. The third party server, during or after step 370, bills the content publisher 110 in step 375 in some embodiments of the disclosed technology. This billing can be per content changed, per request to change content, or on a flat basis such as per month. The billing can also be per unique visitor using the service simply during a period of time, such as per month.

FIG. 4B shows steps to a method of carrying out an additional embodiments of the disclosed technology to modify content being displayed. Here, the method steps are the same as those described and shown in FIG. 4 except that steps 355 and 360 are carried out by the third party server 130 instead of the viewing device 120 and associated adjustments are made related to this change. In steps 345 and 350, after determining if there is a category previously stored on the viewing device 120, based on the execution of the received code in step 340, a communication channel is opened and data sent from the viewing device 120 to the third party server 130. This can include the content and/or URL selected for receipt by the viewing device 120. This can also include the stored category or other stored data in the viewing device 120. Based on this data sent by the viewing device 120 to the third party server 130, the content, such as using the same URL (uniform resource locator) is downloaded to the third party server 130 and scanned in step 355. The category information gleaned from scanning the content (as described with reference to previous figures) is sent to viewing device in step 360. This category information is then stored in a cookie or other local storage of the viewing device 120 in step 390. The exhibited or displayed version of the content or a part thereof on the viewing device 120 is modified based on sending code in step 370 from the third party server 130 back to the viewing device 120 such that the content is modified in step 380 such as by replacing text or images displayed with altered text or images.

FIG. 5 shows a high level block diagram of devices used to carry out embodiments of the disclosed technology. Device 500 comprises a processor 550 that controls the overall operation of the computer by executing the device's program instructions which define such operation. The device's program instructions may be stored in a storage device 520 (e.g., magnetic disk, database) and loaded into memory 530 when execution of the console's program instructions is desired. Thus, the device's operation will be defined by the device's program instructions stored in memory 530 and/or storage 520, and the console will be controlled by processor 550 executing the console's program instructions. A device 500 also includes one or a plurality of input network interfaces for communicating with other devices via a network (e.g., the internet). The device 500 further includes an electrical input interface. A device 500 also includes one or more output network interfaces 510 for communicating with other devices. Device 500 also includes input/output 540 representing devices which allow for user interaction with a computer (e.g., display, keyboard, mouse, speakers, buttons, etc.). One skilled in the art will recognize that an implementation of an actual device will contain other components as well, and that FIG. 5 is a high level representation of some of the components of such a device for illustrative purposes. It should also be understood by one skilled in the art that the method and devices depicted in FIGS. 1 through 5 may be implemented on a device such as is shown in FIG. 5.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A method of operating a server, comprising:
connecting said server to a first node on a network with a plurality of network nodes;
receiving via said first network node, from a device associated with a content viewer at a second network node:
a) an indication that said device associated with said content viewer has received content from a device associated with a content publisher; and
b) a list of keywords found in said content;
based on said keywords, determining a category of said content;
sending data to said device associated with said content viewer to store said category in a storage device residing at said device associated with said content viewer;
a second receiving, said second receiving being a via said first network node from said device associated with said content viewer:
a) an indication that said content viewer has received at least some additional or same content from said device associated with said content publisher;
b) said category stored in said storage device;
sending data to be executed by said device associated with said content viewer to modify a part of said additional or said same content;
charging a fee to said content publisher for said sending of said data to modify said additional or said same content.

2. The method of operating a server of claim 1, further comprising receiving an indication from said content viewer that content displayed to said device associated with said content viewer has been modified based on said category stored by said content viewer.

3. The method of operating a server of claim 1, wherein said data sent to said device associated with said content viewer to store said category is stored long term only by said device associated with said content viewer.

4. The method of operating a server of claim 1, wherein said server lacks long term storage of any data pertaining to viewing history and said category of said content viewed by said content viewer.

5. The method of operating a server of claim 4, wherein said step of charging a fee to said content publisher is charged based on a determination that content displayed by said content publisher was modified based on said data sent to said device associated with said content viewer to store said category.

6. The method of operating a server of claim 5, where said server makes said determination based, in part, on receiving a version of said data received from said device associated with said content publisher.

7. The method of operating a server of claim 6, wherein:
said content publisher is a plurality of content publishers each providing different content associated with said category and/or additional said categories; and
said version of said data comprises a plurality of said additional said categories viewed by said device associated with said content viewer which were stored on said device associated with said content viewer.

8. The method of operating a server of claim 7, comprising carrying out said step of sending said data to store said category each time content from any of said plurality of content publishers is viewed.

9. The method of operating a server of claim 8, wherein said step of sending data said each time after a first time causes a cookie stored on said device associated with said content viewer to be updated storing multiple said additional categories and a view count for each category of said additional said categories.

10. The method of operating a server of claim 9, further comprising:
receiving an indication that said device associated with said content viewer has requested said content from said previously known content publisher a second time;
determining that content that should be displayed based on one of said view count or time of said each category of said additional categories being stored;
causing display of modified content which is the same as content previously sent from said content publisher to said device associated with said content viewer which is different than said content that was determined should be displayed for purposes of providing a consistent viewing experience.

11. The method of claim 2, wherein said content is modified while being downloaded by said device associated with said content viewer.

12. A method of displaying modified content to a viewer, comprising the steps of:
receiving a request to download at least said static content and sending said static content;
designating at least some of said static content which is changable based on a category of interest of a viewer;
sending with said static content code designed to instruct a device associated with said viewer to upload data with said category of interest to a third party server and modify said static content which is changeable;
wherein said category of interest is determined and stored with said viewer based on prior said static content downloaded.

13. The method of claim 12, further comprising a step of paying a fee to an operator of said third party server, said fee associated with determining said category of interest and modifying said static content with varied content.

14. The method of claim 12, wherein said at least one specific category is a category related to a specific gender and said exhibited content is content of interest to said specific gender.

15. The method of claim 13, wherein said specific gender is determined based on said static content, said static content including a uniform resource locator which comprises a name determined to be of said specific gender.

16. The method of claim 12, wherein instructions are sent to a device associated with said viewer to store said category of interest.

17. The method of claim 15, wherein after sending said instructions, all data which is used to associate said viewer to said category of interest is deleted from said third party server.

18. The method of claim 17, wherein after sending said instructions, said data which is used to associate said viewer to said category of interest is deleted from a device used to carry out said method.

19. The method of claim 12, wherein said third party server stores data about said various categories only short term and said data must be retrieved from said viewer to carry out said step of finding and exhibiting content and paying said fee.

20. The method of claim 13, further comprising a steps of:
determining that said viewer has requested said static content a second time;
determining a new said category of interest of said viewer based on further content viewed by said viewer and reported to said third party server;
repeating sending of said varied content, said varied content exhibited being said content which was previously exhibited in order to provide a consistent viewing experience to said viewer.
